(19) United States
(12) Patent Application Publication
(10) Pub. No.: US 2017/0328764 A1
(43) Pub. Date: Nov. 16, 2017

(54) PORTABLE FOOD SCALES, FOOD SCALE SYSTEMS, AND METHODS OF USING THE SAME

(71) Applicant: REFLEX WIRELESS INC., New York, NY (US)

(72) Inventor: Chun Cheng Tsai, Richmond (CA)

(21) Appl. No.: 15/597,108

(22) Filed: May 16, 2017

Related U.S. Application Data
(60) Provisional application No. 62/336,801, filed on May 16, 2016.

(51) Int. Cl. G01G 19/414; G01G 21/28; G01G 19/415

(52) U.S. Cl. CPC G01G 19/4146; G01G 19/415; G01G 21/283

(57) ABSTRACT

A portable food scale includes: (a) a body portion having an upper body portion and a lower body portion, wherein a cavity is defined between the upper body portion and the lower body portion; (b) a plurality of load cells housed within the cavity; and (c) a plurality of clip portions securing the upper body portion to the lower body portion, each of the clip portions being engaged with at least one of the plurality of load cells.

### CROSS-REFERENCE TO RELATED APPLICATION

This application claims the benefit of U.S. Provisional Application No. 62/336,801, filed May 16, 2016, the contents of which are incorporated herein by reference.

### BACKGROUND

Increasingly large segments of the population have become more conscious of dietary issues. Portable food scales find widespread use among such population segments. Additionally, such individuals tend to increasingly utilize mobile electronic devices (e.g., cellular telephones, smart phones, tablets, etc.) to track aspects of their lifestyle.

Thus, it would be desirable to provide improved portable food scales, food scale systems, and methods of using the same, including improvements related to the use of mobile electronic devices.

### SUMMARY

According to an exemplary embodiment of the invention, a portable food scale is provided. The portable food scale includes: (a) a body portion having an upper body portion and a lower body portion, wherein a cavity is defined between the upper body portion and the lower body portion; (b) a plurality of load cells housed within the cavity; and (c) a plurality of clip portions securing the upper body portion to the lower body portion, each of the clip portions being engaged with at least one of the plurality of load cells.

According to another exemplary embodiment of the invention, a portable food scale is provided. The portable food scale includes: (a) a body portion; and (b) a sensor assembly engaged with the body portion, the sensor assembly including a sensor portion for sensing at least one of (i) proximity of a user and (ii) contact of a user, the sensor assembly being configured to distinguish between motion patterns of the user with respect to the sensor portion.

According to yet another exemplary embodiment of the invention, a food scale system is provided. The food scale system includes a plurality of distinct food scales, each of the food scales including at least one load cell and a microprocessor. The plurality of distinct food scales are configured to operate as a single food scale to weigh a food item. The plurality of distinct food scales include a master food scale, and at least one slave food scale. Each of the at least one slave food scale is configured to transmit data related to a weight measured using the at least one load cell of the at least one slave food scale to the master food scale.

According to yet another exemplary embodiment of the invention, a portable food scale is provided. The portable food scale includes: (a) a microprocessor; (b) at least one load cell; and (c) an RFID reader for detecting the identity of an item such that the microprocessor can utilize the identity of the item.

According to yet another exemplary embodiment of the invention, a portable food scale is provided. The portable food scale includes: (a) a microprocessor; (b) at least one load cell; and (c) an imaging device for imaging an identity of an item such that the microprocessor can utilize the identity of the item.

According to yet another exemplary embodiment of the invention, a portable food scale is provided. The portable food scale includes: (a) a body portion; (b) a microprocessor positioned in the body portion; (c) at least one load cell positioned in the body portion; (d) a lid covering the body portion; and (e) a flexible, transparent covering configured to be secured to the lid.

According to yet another exemplary embodiment of the invention, a portable food scale is provided. The portable food scale includes: (a) a microprocessor; (b) at least one load cell; and (c) a microphone, the microphone being configured to receive audible information from a user of the portable food scale related to the identity of an item.

According to yet another exemplary embodiment of the invention, a portable food scale is provided. The portable food scale includes: (a) a microprocessor; (b) at least one load cell; and (c) an external display connected to the portable food scale for displaying a weight of an item weighed using the portable food scale.

According to yet another exemplary embodiment of the invention, a portable food scale is provided. The portable food scale includes: (a) a microprocessor; (b) at least one load cell; and (c) a projection system for projecting an output weight of an item weighed using the portable food scale to a location external to the portable food scale.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1 is a top perspective view of a portable food scale in accordance with an exemplary embodiment of the invention;

FIG. 2 is a side view of the portable food scale of FIG. 1;

FIG. 3 is another side view of the portable food scale of FIG. 1;

FIG. 4 is a bottom view of the portable food scale of FIG. 1;

FIG. 5 is a exploded perspective view of the portable food scale of FIG. 1;

FIG. 6A is a bottom perspective view of a lower body portion of the portable food scale of FIG. 1;

FIG. 6B is a top perspective view of the lower body portion of FIG. 6A, and additional elements of the portable food scale of FIG. 1;

FIG. 7A is a bottom view of an upper body portion, and additional elements, of the portable food scale of FIG. 1;

FIG. 7B is top view of the upper body portion of FIG. 7A;

FIG. 8 is a bottom view of an upper body portion, and additional elements, of a portable food scale in accordance with an exemplary embodiment of the invention;

FIG. 9 is a top view of a food scale system in accordance with an exemplary embodiment of the invention;

FIG. 10A is a perspective view of a lid of a portable food scale, and a flexible, transparent covering for the lid, separated from one another in accordance with an exemplary embodiment of the invention;

FIG. 10B is a perspective view of the lid and the flexible, transparent covering, of FIG. 10A, coupled to one another;

FIG. 11 is a block diagram view of elements of a portable food scale of the invention electrically connected to one another in accordance with an exemplary embodiment of the invention;

FIG. 12 is a top view of a portable food scale including an external display in accordance with an exemplary embodiment of the invention; and

FIG. 13 is a top view of a portable food scale including a projection system in accordance with an exemplary embodiment of the invention.

### DETAILED DESCRIPTION

In accordance with certain exemplary embodiments of the present invention, portable food scales, and related food scale systems, are provided. A user of the food scale may operate the portable food scale in connection with a software application on a computer device (e.g., a mobile phone, a smart phone, a tablet, a laptop computer, a desktop computer, etc.). The portable food scale may communicate with the computer device using wired connections (e.g., through a micro USB port in the portable food scale), via a wireless connection, etc. Through such communication, the user (and possibly a company with which the user is affiliated, such as a weight loss company) is able to determine information about a food item being consumed by the user such as, for example, the weight of the food item, the identity (type of food) of the food item, etc.

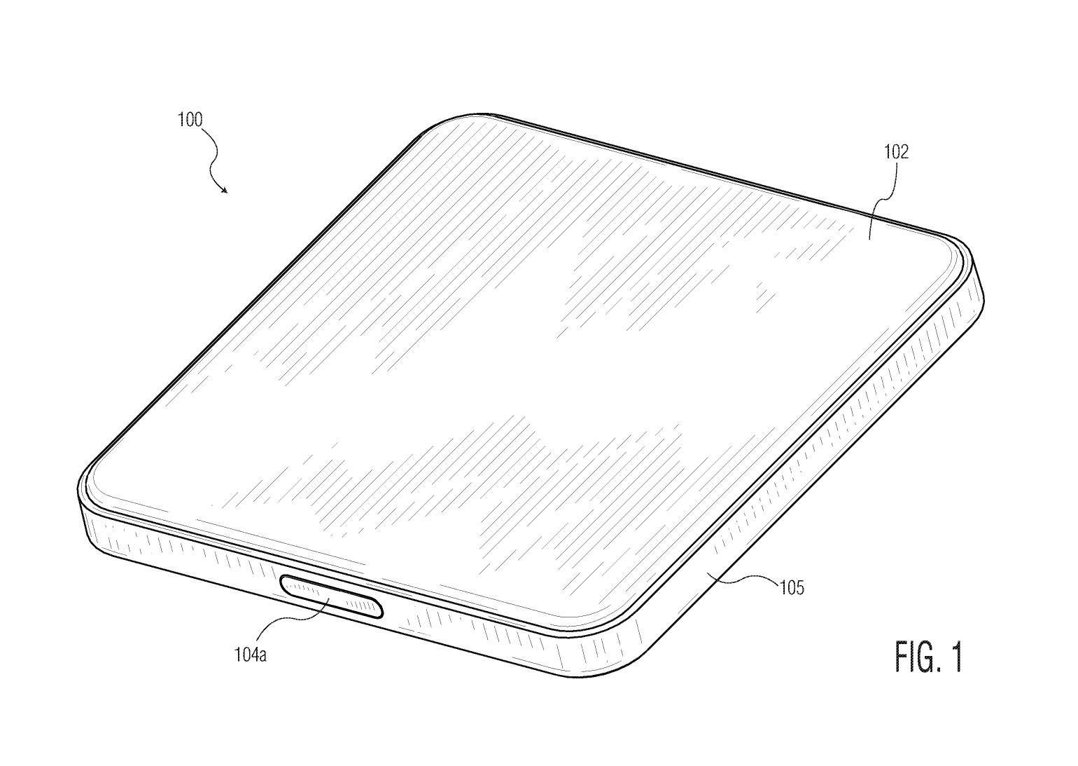

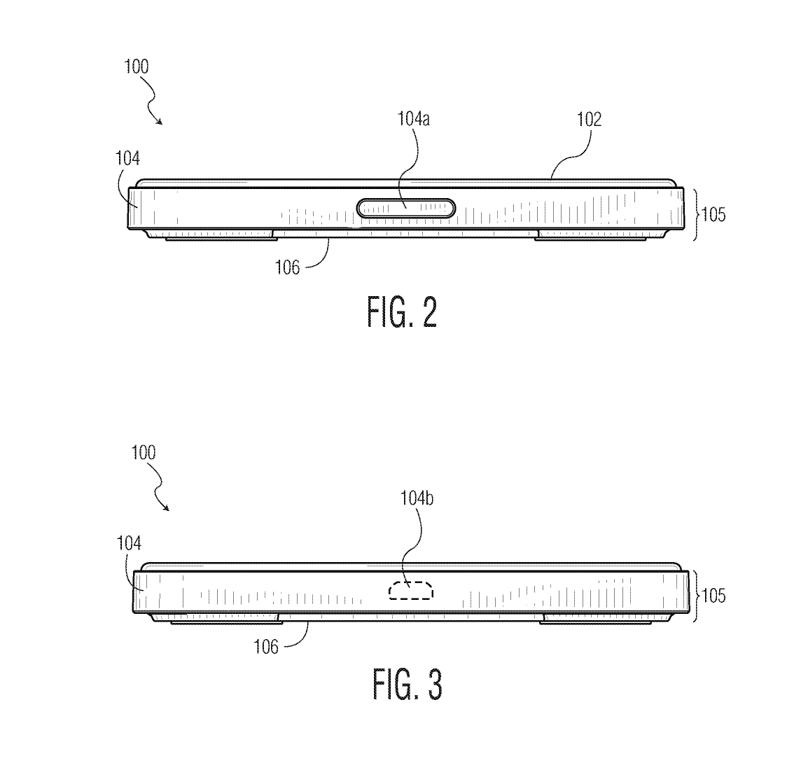

FIG. 1 illustrates a portable food scale 100 including a body portion 105 and a lid 102 covering an upper part of body portion 105. Also shown in FIG. 1 is a sensor assembly 104a. FIG. 2 is a side view of portable food scale 100 illustrating the two primary components of body portion 105, namely, upper body portion 104 and lower body portion 106. Sensor assembly 104a is also visible in the side view shown in FIG. 2. The portion of sensor assembly 104a visible in FIG. 2 is a sensor portion (e.g., a touch sensor, a proximity sensor, etc.) for sensing at least one of (i) proximity of a user and (ii) contact of a user. Sensor assembly 104a is configured to distinguish between motion patterns of the user with respect to the sensor portion. For example, in one embodiment, sensor assembly 104a is able to distinguish between 3 types of contacts (e.g., the sensor portion may include a plurality of different sensors to provide this capability). The first “contact” is a direct touch (e.g., of a finger) which may be used to turn portable food scale 100 on and off. The second “contact” is a swipe (e.g., of a finger) from right to left that may be used to set the “tare” of portable food scale 100 to zero. The third “contact” is a swipe (e.g., of a finger) from left to right that may be used to change the unit of weight measure (e.g., from English to metric, or vice-versa, etc.) of portable food scale 100. Of course, these three types of contact are exemplary in nature, and other contact patterns (or proximity patterns) are contemplated within the scope of the invention.

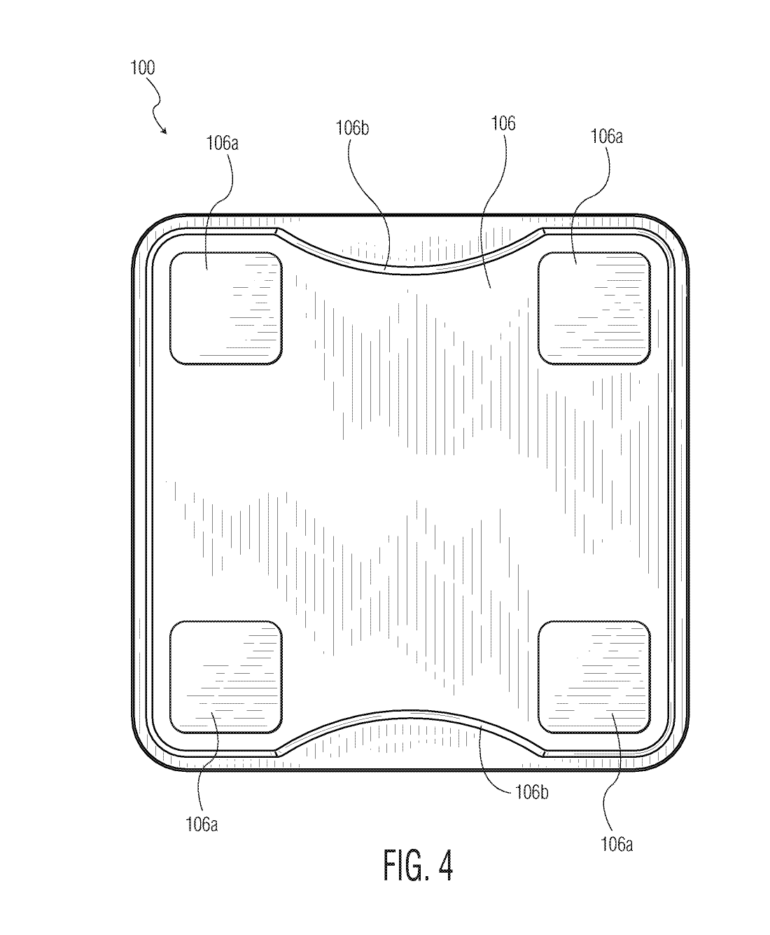

FIG. 3 is an opposite side view, as compared to FIG. 2, of portable food scale 100. Micro USB port 104b is shown in the side view of FIG. 3, and may be used to provide power and communications to and/or from portable food scale 100. More specifically, connection to micro USB port 104b may be used to recharge a battery in portable food scale 100, or to facilitate data communication to another device (e.g., a mobile device such as a mobile phone, a computer, a tablet, an external display, etc.). While a micro USB port is illustrated and described herein, it is understood that other types of connections now available (or available in the future) are contemplated to provide this functionality.

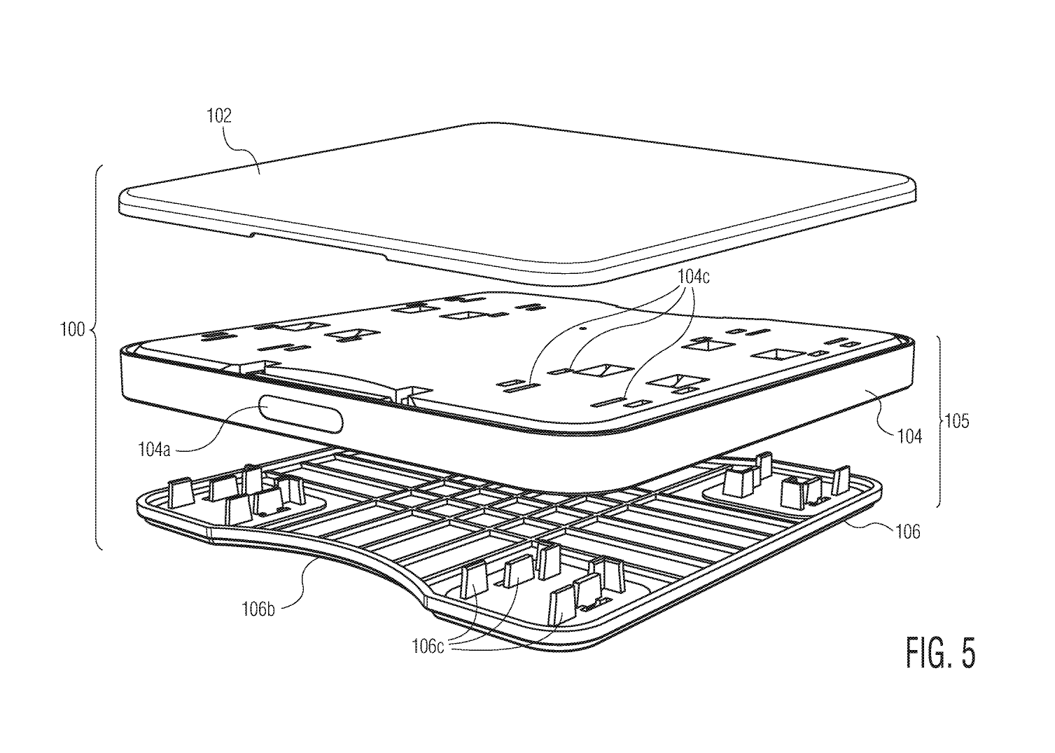

FIG. 4 is a bottom view of portable food scale 100, and illustrates a bottom surface of lower body portion 106. Lower body portion 106 defines curved portions 106b which are used for mating with corresponding curved portions of upper body portion 104. Also shown in FIG. 4 are feet 106a which are secured to a lower surface of lower body portion 106, for example, using adhesive.

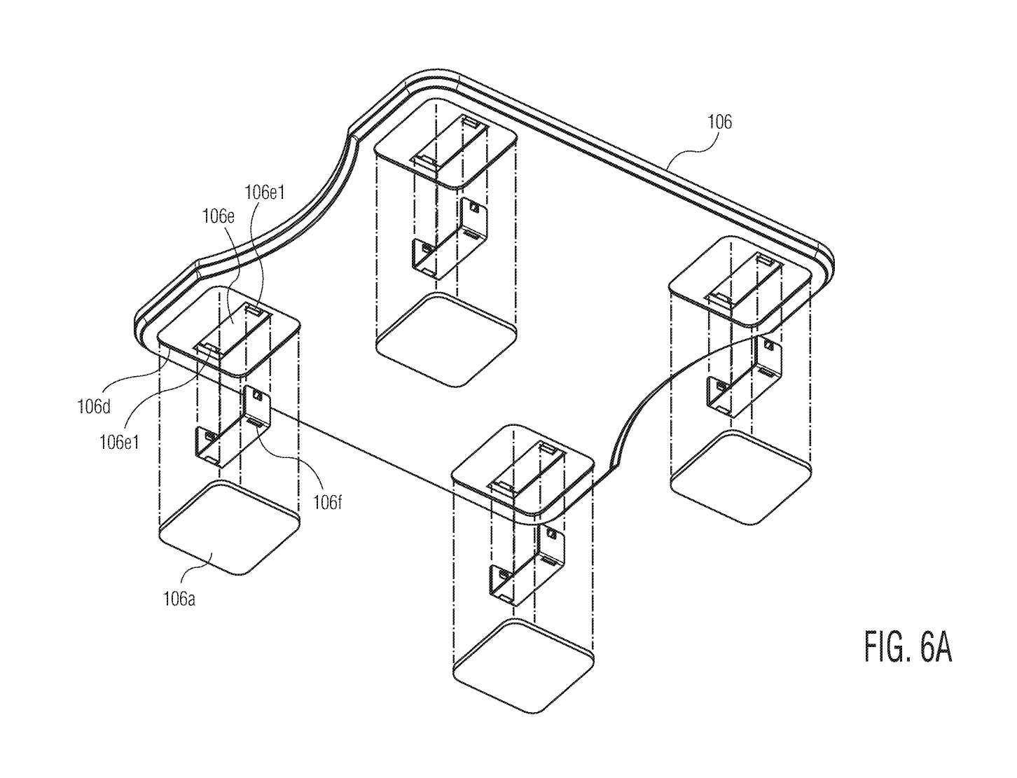

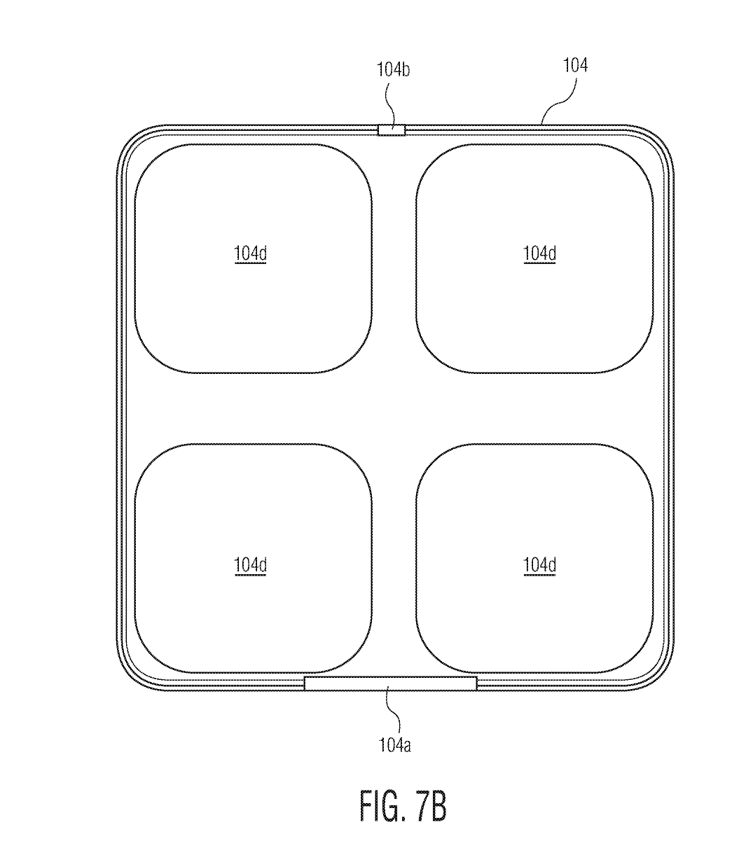

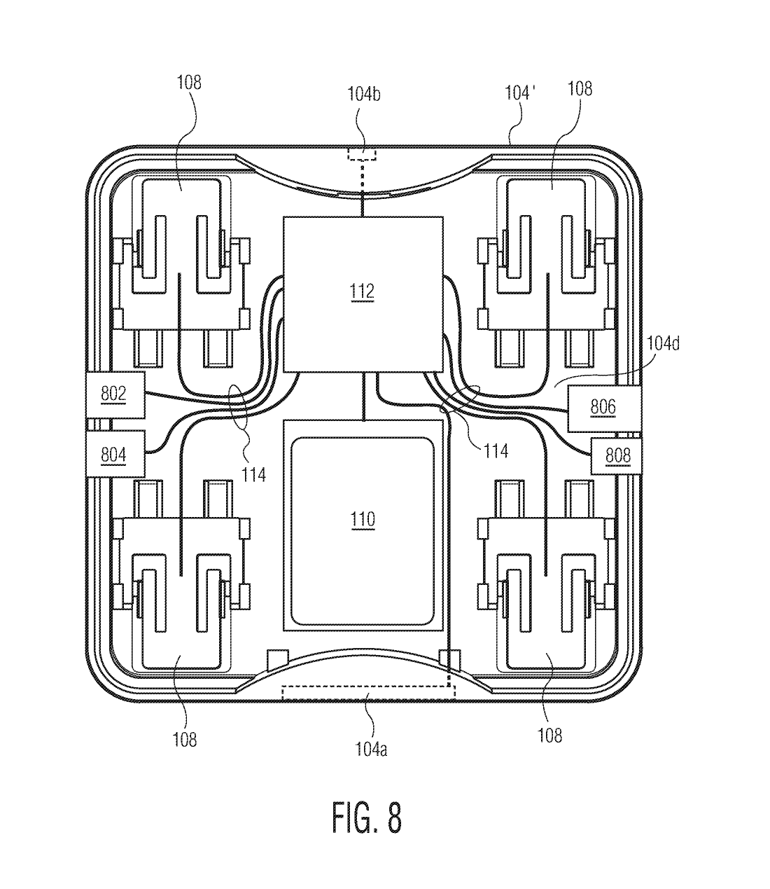

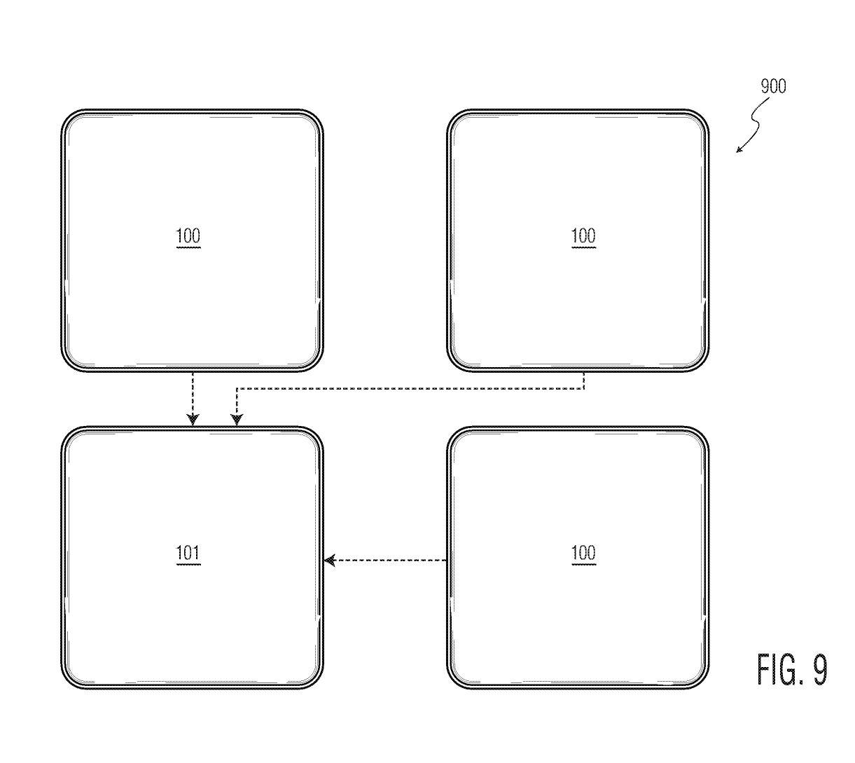

FIG. 5 is an exploded view of portable food scale 100 including lid 102 (e.g., a stainless steel lid) and body portion 105, where body portion 105 includes upper body portion 104 and lower body portion 106. Upper body portion 104 and lower body portion 106 may be formed of, for example, molded plastic. Alignment protrusions 106c of lower body portion 106 are useful for aligning lower body portion 106 with upper body portion 104, for example, by insertion into apertures 104c. Sensor assembly 104a is also shown in FIG. 5. Curved portion 106b is also shown in FIG. 5, however, the corresponding (mating) curved surface of upper body portion 104 is not visible in FIG. 5 (see, e.g., FIGS. 7A and 8).

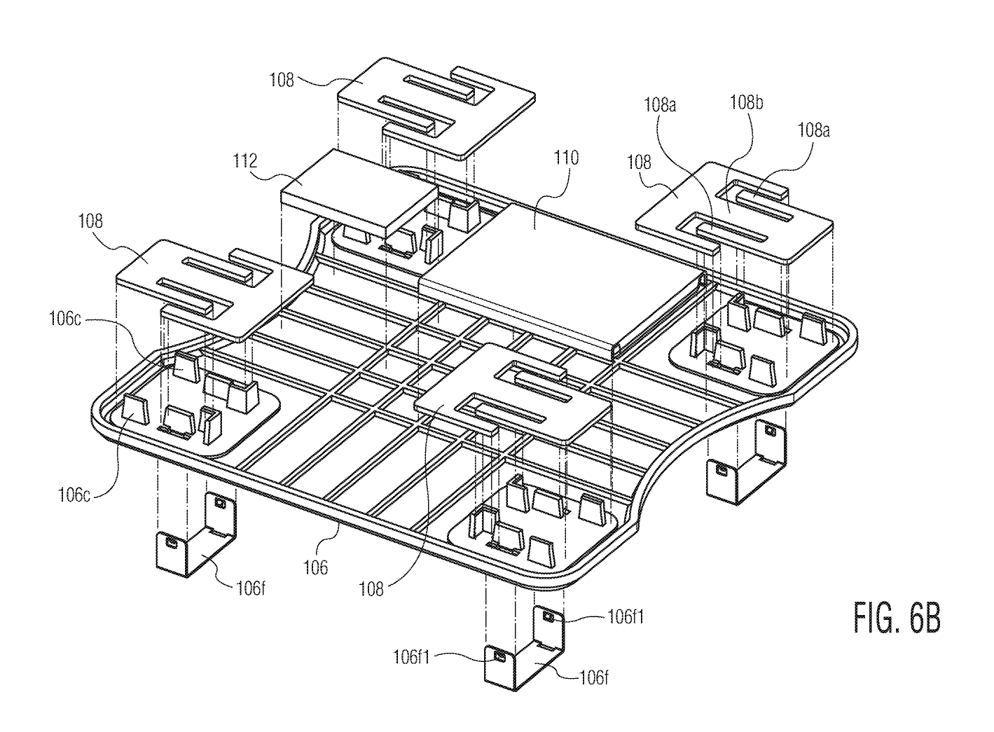

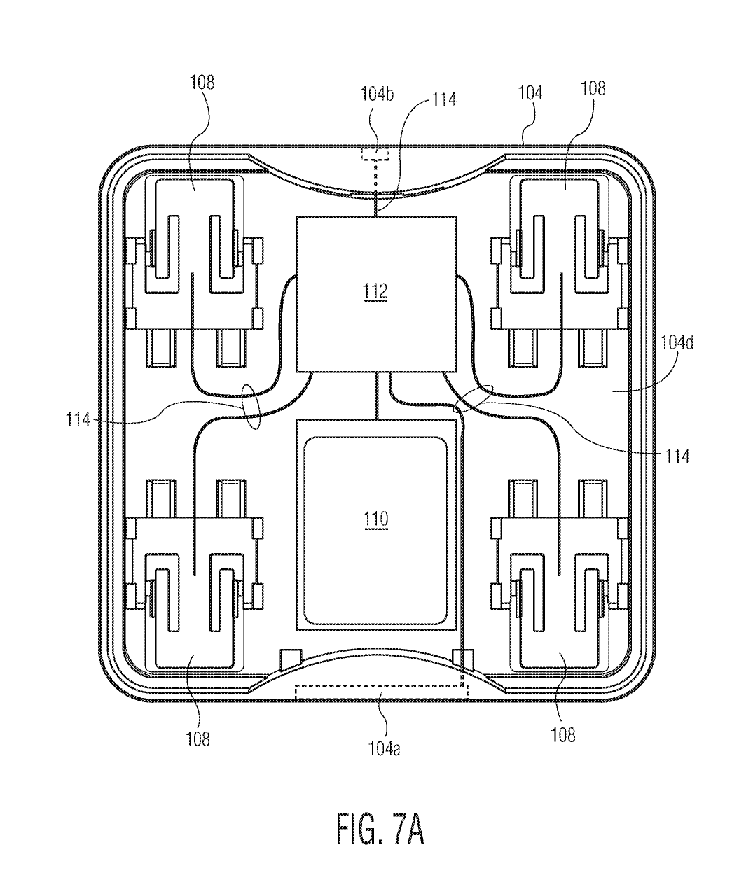

FIG. 6A is a bottom perspective view of lower body portion 106. Lower body portion 106 defines depressions 106d and 106e. Depression 106e is further depressed into the bottom surface of lower body portion 106 as compared to depression 106d. Apertures 106e1 are defined by the lower surface of lower body portion 106 within depression 106e. Apertures 106e1 are configured to receive side walls of clips 106f. After clips 106f are engaged with depression 106e (including insertion of the side walls into apertures 106e1) feet 106a are secured to the lower surface of lower body portion 106 at a corresponding depression 106d. As is shown in FIG. 6A, the shape of depression 106d substantially matches the shape of each of the feet 106a. An adhesive material may be provided on the surface of each of the feet 106a that will be in contact with the lower surface of lower body portion 106 adjacent depression 106d.

FIG. 6B is a perspective view of an upper surface of lower body portion 106. Clips 106f and protrusions 106c, described above with respect to FIG. 6A, are shown in FIG. 6B. As shown in FIG. 6B, each of the side walls of clip 106f includes a pointed engagement portion 106f1. Also shown in FIG. 6B are certain elements of portable food scale 100 that will be positioned between upper body portion 104 and lower body portion 106 (e.g., in a cavity 104d, see FIGS. 7A and 8) including, for example, battery 110, microprocessor 112 and load cells 108. Each load cell 108 is configured to be positioned adjacent a corresponding group of protrusions 106c. Each load cell 108 will be secured to upper body portion 104. Engagement portions 106f of a corresponding clip 106f will become engaged with a cantilever spring portion 108a of load cell 108, thereby securing upper body portion 104 to lower body portion 106. That is, side walls of clip 106f extend through lower body portion 106 and engage with a portion of load cells 108 (which are secured to upper body portion 104) to secure upper body portion 104 to lower body portion 106. As shown in FIG. 6B each load cell 108 includes a primary member 108b and a pair of cantilever spring portion 108a positioned on opposite sides of the primary member 108b. Certain of protrusions 106c are configured to pressure cantilever spring portions 108a of load cell 108.

FIG. 7A illustrates a lower surface of upper body portion 104, and shows the position of load cells 108, battery 110, and microprocessor 112. Wiring 114 (shown as individual conductors, but of course, may include any number of conductors) are shown interconnecting the various elements. For example, wiring 114 extends between each load cell 108 and microprocessor 112 such that microprocessor 112 can determine weight information detected by the corresponding load cell 108 in order to determine the weight of a food item (or other item) placed onto portable food scale 100. Wiring 114 is also shown between micro USB port 104b and microprocessor 112, between sensor 104a and microprocessor 112, and between microprocessor 112 and battery 110. A cavity 104d is formed in the space between upper body portion 104 and lower body portion 106, and is marked in FIG. 7A.

FIG. 7B is a top view of upper body portion 104 and again illustrates sensor assembly 104a and micro USB port 104b. Also shown in FIG. 7B are adhesive pads 104d. When lid 102 is attached to upper body portion 104, an adhesive surface of each of adhesive pads 104d is exposed to be in contact with a bottom surface of lid 102 to retain lid 102 in place with respect to body portion 105.

FIG. 8 illustrates an alternative embodiment of upper body portion 104 labeled as 104′. Additional elements are shown in FIG. 8, that are not shown in FIG. 7A, namely, an imaging device 802 (e.g., a camera for imaging an identity of an item such that the microprocessor can utilize the identity of the item), a bluetooth device 804, an RFID reader 806 (e.g., an RFID reader for detecting the identity of an item such that the microprocessor can utilize the identity of the item, wherein the RFID reader may include an RFID antenna, such), and a microphone/speaker 808 (e.g., a microphone configured to receive audible information from a user of the portable food scale related to the identity of an item). Each of elements 802, 804, 806, and 808 are wired to microprocessor 112 using wiring 114, to provide information related to their respective specific purpose.

While such elements 802, 804, 806, and 808 are shown as discrete elements to be provided in cavity 104d, it is understood that more than one of the elements may be integrated or included on a single structure (e.g., a single circuit board). Further, additional elements (not shown) may be included, such as a permanent memory storage device (e.g., an EEPROM device) to include certain information about the portable food scale (e.g., a serial number of the food scale, a model number of the food scale, an identity of the user of the food scale, etc.). Such information may be used to track data associated with the user, such as the their location, the type of food they are eating, the quantity of food they are eating, etc.

As will be appreciated by those skilled in the art, any one (or more than one) of elements 802, 804, 806, and 808 may be included in a portable food scale in connection with the invention with or without others of the elements.

An exemplary operation of portable food scale 100 (or another food scale within the scope of the invention) is now provided. Portable food scale is turned on, for example, by direct contact with a sensor portion of sensor assembly 104a. A software application on a computer device is also started (e.g., an “app” on a mobile phone, tablet, or other computer device). When the software application is started with portable food scale 100 already turned on, portable food scale 100 may desirably connect to the software application automatically (e.g., the connection between food scale 100 and the computer device may be wired, such as through the micro USB port 104b; the connection between food scale 100 and the computer device may be wireless, such as through a radio included with food scale 100 such as bluetooth device 804 described herein; etc.). As will be appreciated by those skilled in the art, the software application may be used to track and/or manage the food consumed by the user, such as caloric intake and other food related data.

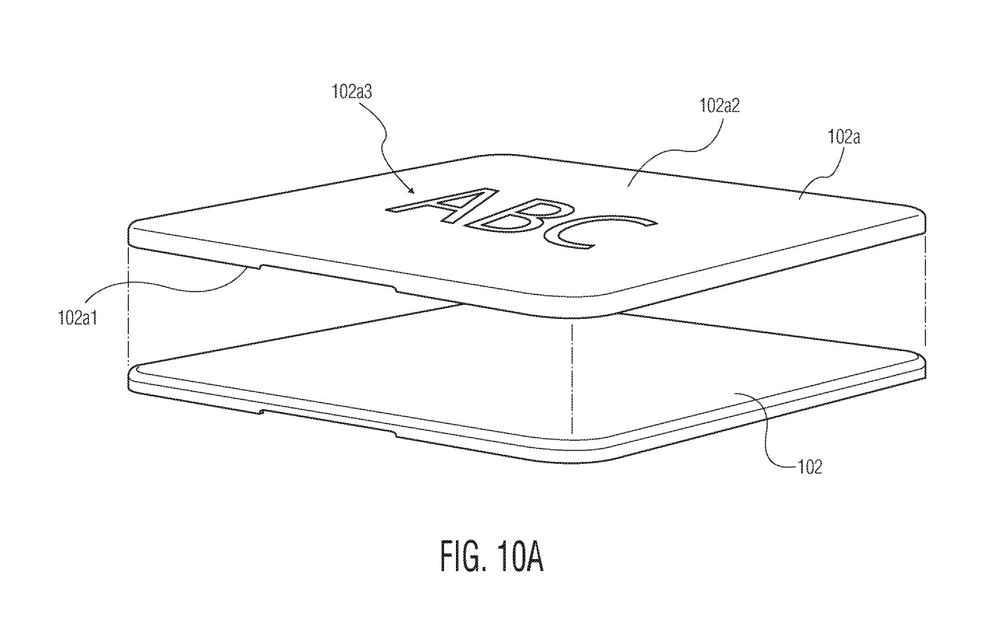

With portable food scale 100 powered on, and connected to the software application, the user places a food item (or a non-food item) on portable food scale 100. Then portable food scale 100 (or a food scale system, such as in FIG. 9 described below) may determine the weight of the food item being weighed. However, it is important that the food item be identified (or identifiable) in order to maximize the utility of the combination of food scale 100 and the software application. The food item may be identified in a number of different ways. For example, the user may manually enter the identity (or type of) food item into the software application on the computer device. In another example, the user may use an imaging device (e.g., imaging device 802 described above, such as a camera) to read a UPC code or other indication on the product packaging to determine the identity (or type of) food item. In another example, the user may use an RFID reader (e.g., such as RFID reader 806 including an RFID antenna, described above, such as a camera) to use radio frequency identification techniques in connection with the product packaging to determine the identity (or type of) food item, for example, by reading food codes from the product packaging.

In yet another example, a microphone/speaker (such as element 808 described herein) may be used. For example, portable food scale 100 may “speak” and “ask” the user to verbally specify what type of food is on the scale. The user will speak what food it is, and food scale 100 will transmit the voice file (e.g., a .wav file) to the computer device (e.g., a smart phone). This voice file may then be transmitted to a data service included in the invention for voice analysis to identify the words. Then a food database may be searched to associate the weight with the food in the software application. If the food item identity is not found, the scale may “speak” and “ask” the user to use the software application to create a custom food or further specify the food type by other input methods (e.g., bar code scanning, keyword search).

FIG. 9 is a top view of a food scale system 900 including a plurality of portable food scales 100 (and one master portable food scale 101), as described herein. The plurality of food scales 100/101 Each of the illustrated portable food scales 100 are distinct from one another, and may include the elements described above with respect to portable food scale 100 (or other food scales described herein) including, for example, at least one load cell and a microprocessor. The group of portable food scales 100/101 (shown as being four portable food scales, but of course may include, any desired number of portable food scales) is configured to operate as a single food scale to weigh a food item (or other item). That is, for example, an item to be weighed may be too large or too heavy to be weighed using a single portable food scale 100. Thus, a group of portable food scales is used to operate as a single food scale. As shown in FIG. 9 the plurality of food scales includes three portable (slave) food scales 100 and a master portable food scale 101. Each of the three (or whatever desired number) of slave food scales 100 is configured to transmit data related to a weight measured using that slave food scale to the master food scale 101 through a wire connection (e.g., a USB connection, not shown), through a wireless connection, etc. The master food scale 101 may then determine the actual weight of the item being weighed using the data provided by each of the slave food scales 100, and its own information.

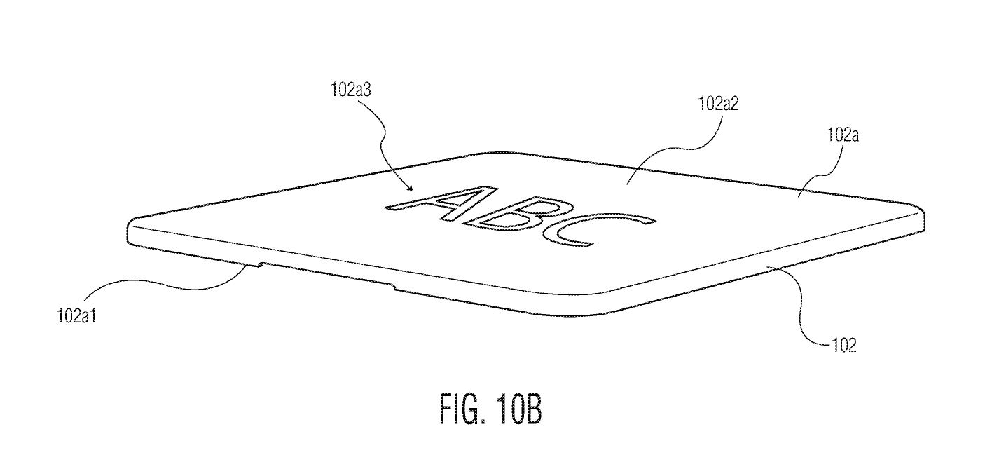

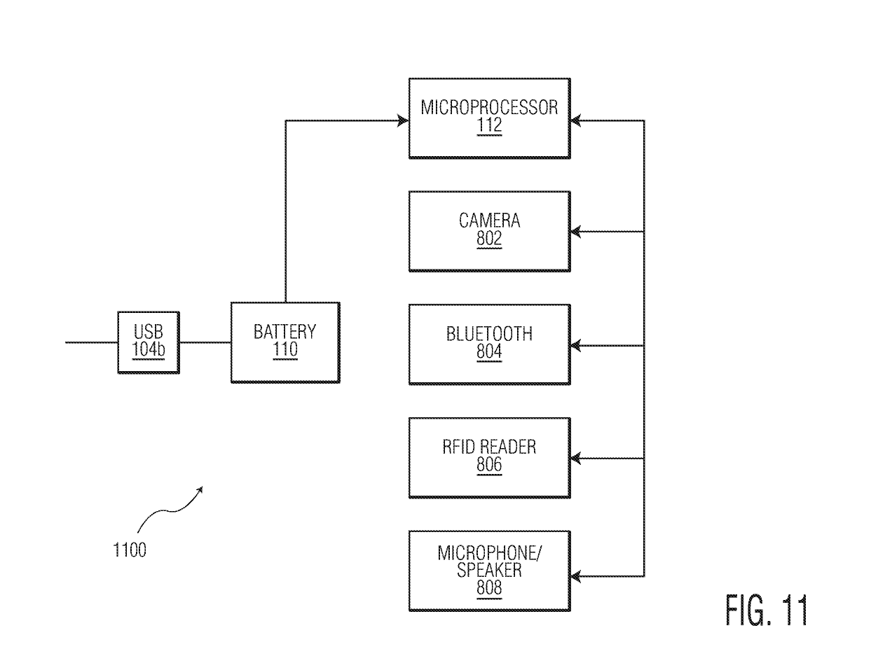

It may be desirable to provide a protective cover for the upper surface of lid 102, for example, to avoid scratches to the upper surface of lid 102 (similar to the protection one uses for a screen of a mobile communication device). Further, it may be desired to provide some type of textual or graphical information desired by the user of a food scale on the upper surface of the lid 102. Such information may be, for example, information related to the user themselves, or a group to which a user belongs, or any other information desired by the user. FIG. 10A illustrates a thin flexible, transparent cover 102a (e.g., which may be formed of thermoplastic polyurethane or another thin, flexible, transparent material) for covering an upper surface of lid 102. A bottom surface 102a1 of flexible transparent cover 102a (which may include an adhesive material) is brought into contact with an upper surface of lid 102. An upper surface 102a2 of flexible transparent cover 102a includes text 102a3 (referenced above) as desired by the user. Text 102a3 (which is illustrated as “ABC”) may be any type of message such as a user name, identity, words of encouragement for the user, custom printing as desired by the user, etc. FIG. 10B illustrates flexible transparent cover 102a now secured to lid 102 using the adhesive referenced above. Use of such a flexile transparent cover 102a may provide the additional benefit of expand the weighing surface area of food scale 100.

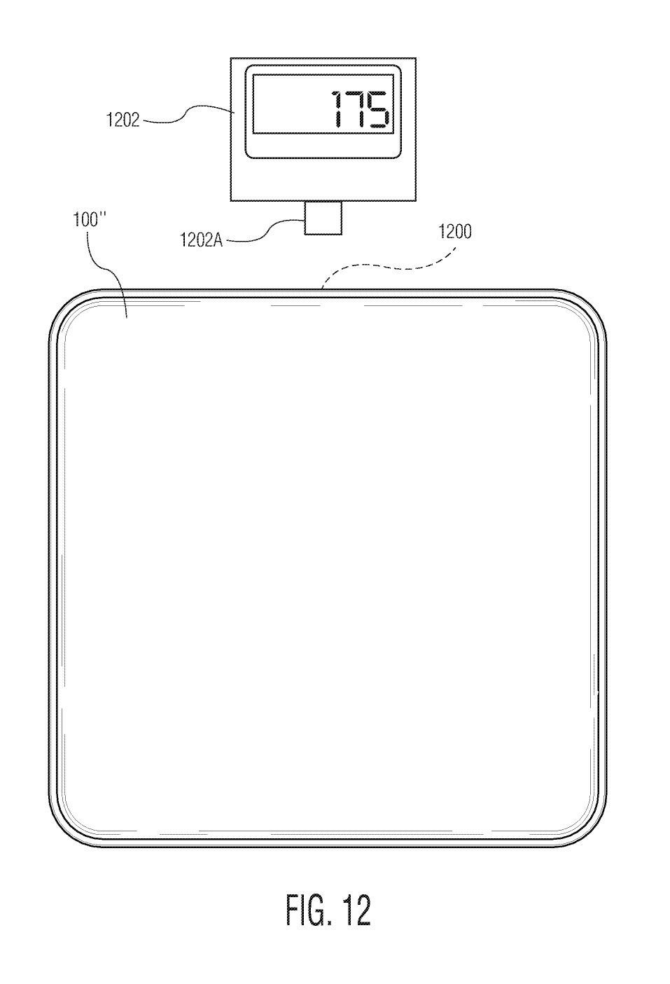

FIG. 11 is a block diagram view of an exemplary system 1100 of elements of a portable food scale 100. The elements are shown in an exemplary electrical configuration, however, it is understood that different electrical configurations are contemplated. In FIG. 11 electrical power is brought into a portable food scale 100 through micro USB port 104b and is then transmitted to battery 110. The electrical power is then transmitted to microprocessor 112, which provides power to each of camera 802, bluetooth system 804, RFID reader 806, and microphone/speaker 808. Also shown in FIG. 11 is the bidirectional transmission of data between microprocessor 112 and each of camera 802, bluetooth system 804, RFID reader 806, and microphone/speaker 808.

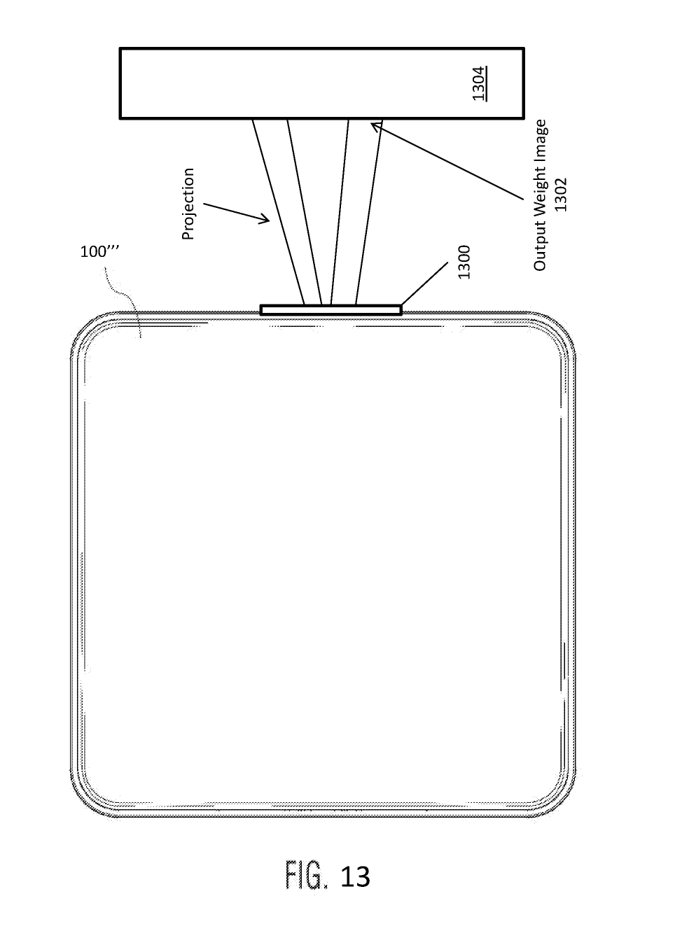

As described herein, the weight output of portable food scale 100 may be viewed by a user on a computer device (e.g., a smart phone with an appropriate software application)—where data may be provided to the computer device using bluetooth technology (e.g., see bluetooth device 804 in FIGS. 8 and 11). However, in connection with alternative embodiments of the present invention, an external display may be provided (e.g., connected to portable food scale 100 using a USB connection, connected to portable food scale 100 using a short range RF connection, etc.). For example, FIG. 12 illustrates a portable food scale 100″ (similar to food scale 100 described herein, but also including a female USB connector 1200). Display 1202, including USB connector 1202a, is configured to be plugged into female USB connector 1200 such that a weight of an item weighed using portable food scale 100″ may be displayed. Of course, additional information may be displayed on display 1202. Further, different technologies (other than USB connectors) may be used to a connect a display to food scale 100″.

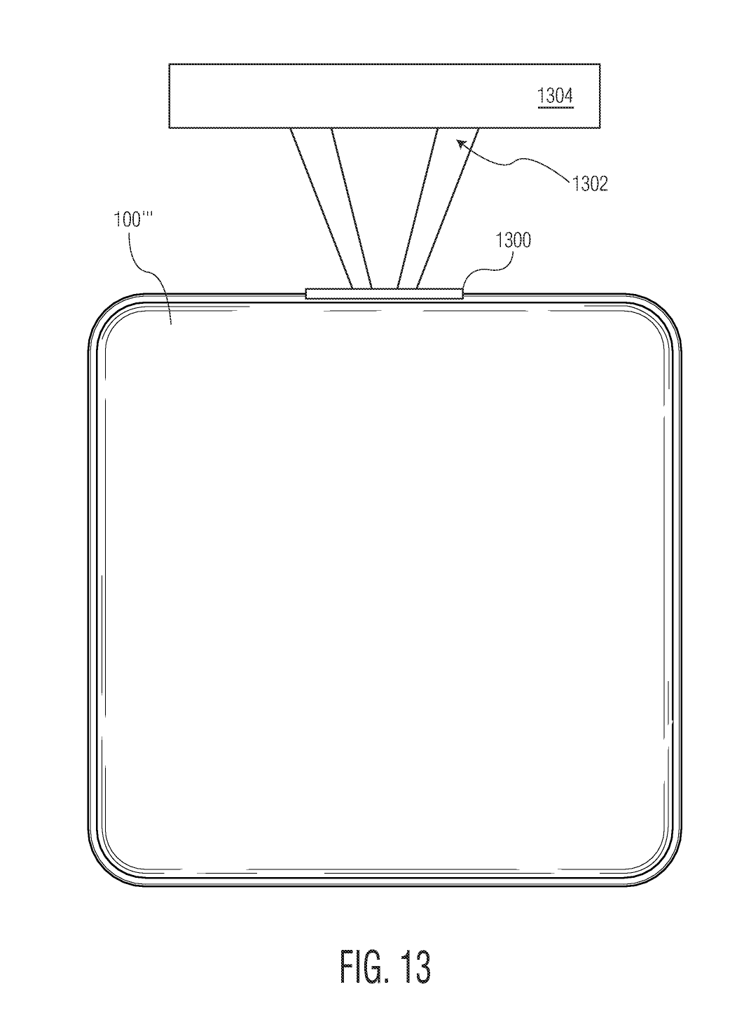

Further, in another example, a portable food scale may include projection capabilities (e.g., a small laser LED projection system) for outputting the weight readout of the scale. More specifically, referring to FIG. 13, portable food scale 100′″ includes a projection system 1300 (e.g., a laser LED projection system) for projecting an output weight image 1302 of an item weighed using the portable food scale to a location 1304 (e.g., a wall, a surface, etc.) external to the portable food scale. For example, output weight image 1302 is an indication of the weight of the item being weighed using a selected unit of measure (e.g., ounces, pounds, kilograms, etc.)

Although the present invention has been described primarily with respect to weighing of food items, it is not limited thereto. The teachings of the present invention have application to portable scales, and scale systems, for weighing other items.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A portable food scale comprising:
(a) a body portion having an upper body portion and a lower body portion, wherein a cavity is defined between the upper body portion and the lower body portion;
(b) a plurality of load cells housed within the cavity; and
(c) a plurality of clip portions securing the upper body portion to the lower body portion, each of the clip portions being engaged with at least one of the plurality of load cells.

2. The portable food scale of claim 1 further comprising a microprocessor, and an RFID reader for detecting the identity of an item such that the microprocessor can utilize the identity of the item.

3. The portable food scale of claim 1 further comprising a microprocessor, and an imaging device for imaging an identity of an item such that the microprocessor can utilize the identity of the item.

4. The portable food scale of claim 1 further comprising a microprocessor positioned in the body portion, a lid covering the body portion, and a flexible, transparent covering configured to be secured to the lid.

5. The portable food scale of claim 1 further comprising a microprocessor, and a microphone, the microphone being configured to receive audible information from a user of the portable food scale related to the identity of an item.

6. The portable food scale of claim 1 further comprising a microprocessor, and an external display connected to the portable food scale for displaying a weight of an item weighed using the portable food scale.

7. The portable food scale of claim 6 wherein the external display is connected to the portable food scale using at least one of (i) a USB connection and (ii) a short range RF connection.

8. The portable food scale of claim 1 further comprising a microprocessor, and a projection system for projecting an output weight of an item weighed using the portable food scale to a location external to the portable food scale.

9. The portable food scale of claim 8 wherein the projection system is a laser LED projection system.

10. The portable food scale of claim 1 further comprising a sensor assembly engaged with the body portion, the sensor assembly including a sensor portion for sensing at least one of (i) proximity of a user and (ii) contact of a user, the sensor assembly being configured to distinguish between motion patterns of the user with respect to the sensor portion.

11. A portable food scale comprising:
(a) a body portion; and
(b) a sensor assembly engaged with the body portion, the sensor assembly including a sensor portion for sensing at least one of (i) proximity of a user and (ii) contact of a user, the sensor assembly being configured to distinguish between motion patterns of the user with respect to the sensor portion.

12. The portable food scale of claim 11 wherein the body portion includes an upper body portion and a lower body portion, and a cavity is defined between the upper body portion and the lower body portion, the portable food scale further comprising a plurality of load cells housed within the cavity, and a plurality of clip portions securing the upper body portion to the lower body portion, each of the clip portions being engaged with at least one of the plurality of load cells.

13. The portable food scale of claim 11 further comprising a microprocessor, and an RFID reader for detecting the identity of an item such that the microprocessor can utilize the identity of the item.

14. The portable food scale of claim 11 further comprising a microprocessor, and an imaging device for imaging an identity of an item such that the microprocessor can utilize the identity of the item.

15. The portable food scale of claim 11 further comprising a microprocessor positioned in the body portion, a lid covering the body portion, and a flexible, transparent covering configured to be secured to the lid.

16. The portable food scale of claim 11 further comprising a microprocessor, and a microphone, the microphone being configured to receive audible information from a user of the portable food scale related to the identity of an item.

17. The portable food scale of claim 11 further comprising a microprocessor, and an external display connected to the portable food scale for displaying a weight of an item weighed using the portable food scale.

18. The portable food scale of claim 11 further comprising a microprocessor, and a projection system for projecting an output weight of an item weighed using the portable food scale to a location external to the portable food scale.

19. The portable food scale of claim 18 wherein the projection system is a laser LED projection system.

20. A food scale system comprising:
a plurality of distinct food scales, each of the food scales including at least one load cell and a microprocessor,
the plurality of distinct food scales being configured to operate as a single food scale to weigh a food item,
the plurality of distinct food scales including a master food scale, and at least one slave food scale, each of the at least one slave food scale being configured to transmit data related to a weight measured using the at least one load cell of the at least one slave food scale to the master food scale.
